(19) United States
(12) Patent Application Publication
(10) Pub. No.: US 2007/0047553 A1
(43) Pub. Date: Mar. 1, 2007

(54) Uplink scheduling in wireless networks

(76) Inventors: Pawel O. Matusz, Rumia (PL); Maciej Dochtorowicz, Gdansk (PL)

Correspondence Address: INTEL CORPORATION;C/O INTELLEVATE, LLC, P.O. BOX 52050, MINNEAPOLIS, MN, 55402, US

(21) Appl. No.: 11/211,288

(22) Filed: Aug. 25, 2005

(51) Int. Cl. H04L 12/56; H04B 7/212

(52) U.S. Cl. 370/395.42; 370/444

(57) ABSTRACT

A medium access control (MAC) scheduler is disclosed for scheduling uplink (UL) traffic by a subscriber station having multiple active service connections. The scheduler may include two types of queue sets, a first type of queue for each unsolicited grant service (UGS) connection and a second type of queue for each and all other non-UGS connections. Upon receipt of an overall bandwidth grant from a base station, data in the first type of queues may be sent first and then data in the second type of queues is sent if there is sufficient remaining burst space in the granted UL frame. The second type of queues may be assigned weight value, and thus scheduled, depending on the type of connection. When serving the second type of queues, initial burst space allocation may be reserved for bandwidth requests to the base station. Additional embodiments and variations are also disclosed.

### BACKGROUND OF THE INVENTION

It is becoming more important to be able to provide telecommunication services to subscribers which are relatively inexpensive as compared to cable and other land line technologies. Further, the increased use of mobile applications has resulted in much focus on developing wireless systems capable of delivering large amounts of data at relatively high speeds.

Development of more efficient and higher bandwidth wireless networks has become increasingly important and addressing issues of how to maximize efficiencies of such networks is an ongoing issue. One such issue relates to efficient scheduling of transmissions in the uplink direction (i.e., from subscriber stations (SS) to centralized access stations or base stations (BS)) while maintaining differentiated levels of service.

### BRIEF DESCRIPTION OF THE DRAWING

Aspects, features and advantages of embodiments of the present invention will become apparent from the following description of the invention in reference to the appended drawing in which like numerals denote like elements and in which:

FIG. 1 is block diagram of an example wireless network according to various embodiments;

FIG. 2 is a sequence diagram showing network bandwidth requests and grants between a subscriber station and a base station according to various embodiments;

FIG. 3 is a block diagram showing example mapping of information into a radio frame according to various embodiments of the present invention;

FIG. 4 is a flow diagram showing a method of scheduling transmission in an uplink direction according to one exemplary embodiment;

FIG. 5 is a flow diagram showing handling of high priority queue information in the method of FIG. 4;

FIG. 6 is a flow diagram showing handling lower priority queue information in the method of FIG. 4; and

FIG. 7 is a block diagram showing an example subscriber station according to various aspects of the present invention.

### DETAILED DESCRIPTION OF THE INVENTION

While the following detailed description may describe example embodiments of the present invention in relation to broadband wireless metropolitan area networks (WMANs), the invention is not limited thereto and can be applied to other types of wireless networks where similar advantages may be obtained. Such networks specifically include, if applicable, wireless local area networks (WLANs), wireless personal area networks (WPANs) and/or wireless wide area networks (WWANs) such a cellular networks and the like. Further, while specific embodiments may be described in reference to wireless networks utilizing Orthogonal Frequency Division Multiplexing (OFDM) and/or Orthogonal Frequency Division Multiple Access (OFDMA) modulation, the embodiments of present invention are not limited thereto and, for example, can be implemented using other modulation and/or coding schemes where suitably applicable.

The following inventive embodiments may be used in a variety of applications including transmitters and receivers of a radio system, although the present invention is not limited in this respect. Radio systems specifically included within the scope of the present invention include, but are not limited to, network interface cards (NICs), network adaptors, fixed user stations, mobile stations, base stations, access points (APs), hybrid coordinators (HCs), gateways, bridges, hubs, routers and other network peripherals. Further, the radio systems within the scope of the invention may include cellular radiotelephone systems, satellite systems, personal communication systems (PCS), two-way radio systems and two-way pagers as well as computing devices including such radio systems such as personal computers (PCs) and related peripherals, personal digital assistants (PDAs), personal computing accessories, hand-held communication devices and all existing and future arising systems which may be related in nature and to which the principles of the inventive embodiments could be suitably applied.

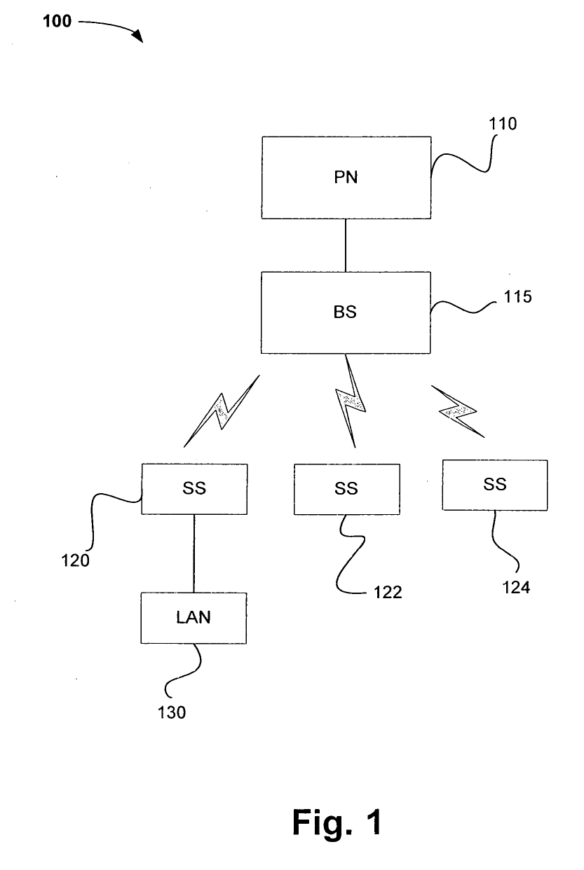

Turning to FIG. 1, a wireless communication network 100 according to various inventive embodiments may be any wireless system capable of facilitating wireless access between a provider network (PN) 110 and one or more subscriber stations 120-124 including mobile subscribers. For example in one embodiment, network 100 may be a wireless broadband network such as those contemplated by various 802.16 standards specified by the Institute of Electrical and Electronics Engineers (IEEE) for fixed and/or mobile subscribers, although the inventive embodiments are not limited in this respect.

In the IEEE 802.16 standards the broadband wireless networks (sometimes referred to as WiMAX, an acronym that stands for Worldwide Interoperability for Microwave Access, which is a certification mark for products that pass conformity and interoperability tests for IEEE 802.16 standards), two principle communicating wireless network nodes are defined including the Base Station (BS) (e.g., base station 115) and the Subscriber Station (SS) (e.g., subscriber stations 120, 122, 124).

In the example configuration of FIG. 1, base station 115 is a managing entity which controls the wireless communication between subscriber stations 120-124 and provider network 110. Subscriber stations 120-124 in turn, may facilitate various service connections of other devices (not shown) to network 110 via a private or public local area network (LAN) 130, although the embodiments are not limited in this respect.

In one implementation base station 115 sends data to subscriber stations 120-124 in downlink (DL) and receives data from stations 120-124 in uplink (UL) in form of radio frames. In one example embodiment, uplink and downlink communications are maintained by sending radio frames at constant, but configurable intervals (e.g. every 5 ms). One notable feature of these types of networks is that a single radio frame may consist of data destined to, or originating from, multiple subscriber stations. As an example, subscriber station 120 may service multiple connections for other devices of local area network 130 all within individual UL and/or DL radio frames.

Bandwidth in a radio link is often limited and thus, base station 115, as the managing entity, may control bandwidth utilization. For example, in downlink, base station 115 may analyze the amount of traffic incoming from provider network 110 and schedule it for transmission to destination subscriber stations, preferably in a fair and efficient manner. Managing base station 115 may also grant bandwidth to subscriber stations 120-124 for use in the uplink direction.

In one example configuration, uplink bandwidth is allocated per frame as a part of the UL or DL radio frame which can be used by a certain SS. If an SS has data to transmit in UL, it may explicitly requests UL bandwidth from the BS by specifying a transmit buffer occupancy for each connection it services.

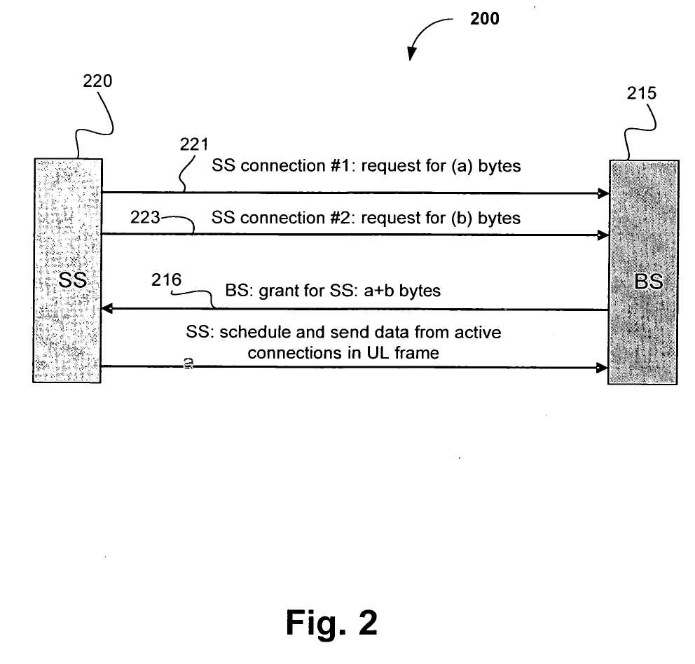

Turning to FIG. 2, as mentioned previously, there may be more than one active connection for a subscriber station 220 and each connection possibly having different quality of service (QoS) requirements. As shown in the example sequence of FIG. 2, subscriber station 220 may have multiple service connections (e.g., SS connection #1, SS connection #2). In one embodiment, each service connection may request 221, 223 its own uplink bandwidth from base station 215. Base station 215 may gather the bandwidth requests for all connections to be served and subsequently grant 216 UL bandwidth to each connection on a per-frame basis. However, as subscriber station 220 is serving more than one connection, the UL grant 216 may be is issued as a whole without specifying the particular connections station 220 serves. Accordingly, it is the responsibility of subscriber station 220 to efficiently use the granted UL bandwidth (a+b bytes) for the various connections it serves in a fair and efficient manner.

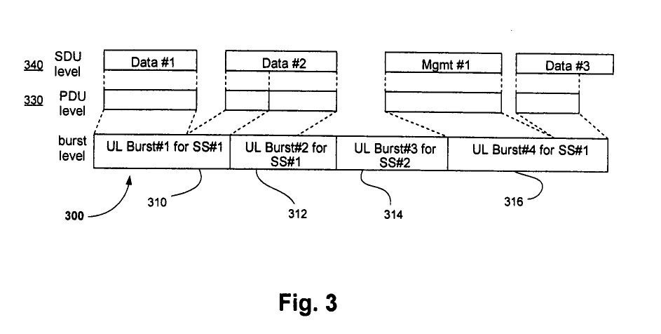

As has already been described, UL bandwidth may be allocated to each SS as part of an appropriate UL radio frame although the allocated parts are not necessarily continuous. Referring to FIG. 3, each radio frame 300 (both UL and DL) consists of a number of bursts 310-316. Each burst 310-316 is a continuous portion of data, which may be sent over the radio interface using a certain modulation and, if desired, FEC (Forward Error Correction) code.

In certain implementations, one whole burst is typically allocated to a single subscriber station or a single connection of a subscriber station having more than one active connection. In the UL frame, several bursts, e.g., 310, 312 and 316, which are not necessarily adjacent, can be allocated to one subscriber station or connection, for example SS#1. Subscriber station MAC (Medium Access Control) PDUs (Protocol Data Units) 330 may be concatenated and MAC SDUs (Source Data Units) 340 fragmented to form shorter MAC PDUs 330 in an effort to more effectively use space available in bursts 310-316. However, not all connections support fragmentation of SDUs 340, for example, management messages on some management connections are not allowed to be fragmented. A subscriber station scheduler should take this into account when trying to find the best MAC PDUs 330 to match with each burst 310-316.

In various inventive embodiments, a subscriber station MAC scheduler will be responsible for scheduling data from all active connections for uplink transmission to a base station in a fair and efficient manner, appropriately prioritizing connections with respect to their QoS requirements and functions.

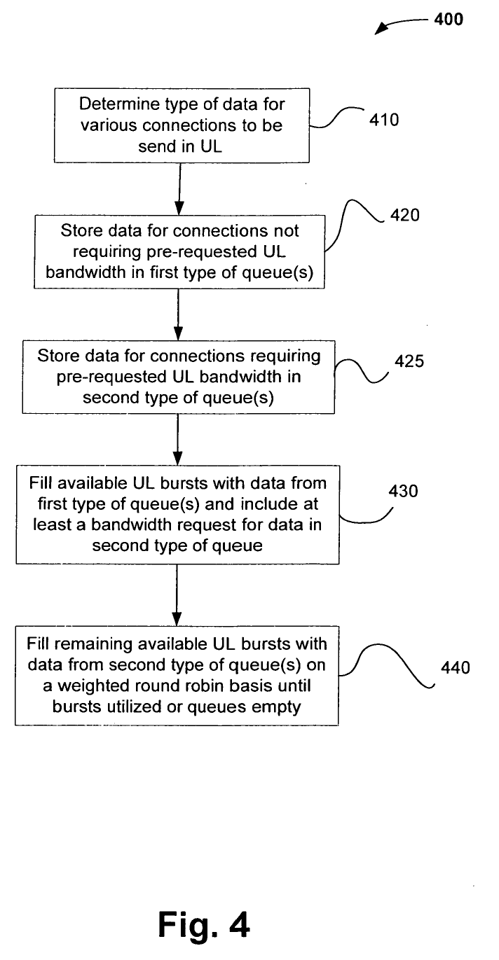

Accordingly, turning to FIG. 4, a method 400 for scheduling uplink transmissions by a subscriber station or mobile unit may generally include determining or identifying 410 the type of data of active connections for uplink transmission; separating 420, 425 the data into two types of priority queues including a first (high) priority type of queue set and a second (lower) priority queue set; filling 430 available UL bursts with data in the high priority queue sets and reserving burst space for at least bandwidth requests for data in the lower priority queue sets. The remaining UL bursts, if any, may then be filled 440 with data from the lower priority queue set.

Critical management information should be transmitted on management connections, taking into account their management levels. Then the remaining uplink bandwidth may be divided among other connections, using appropriate scheduling services implied by the connection's traffic service class. For example, in the 802.16 networks, these types of traffic service classes may include: Unsolicited Grant Service (UGS), which is equivalent to constant bit rate, real-time (RT), non-real-time (nRT) or best effort (BE) traffic service classes. Each uplink connection can therefore be treated as a queue with a certain priority (e.g. RT queues have higher priority than nRT queues) and only UGS connections be treated as queues with strict servicing times (i.e., the highest priority queue).

According to various embodiments of the invention, efficient and robust subscriber station MAC scheduling algorithms or methods (e.g., FIGS. 4, 5 and 6) are disclosed for scheduling data for transmission by IEEE 802.16 Subscriber Station, although the invention is not limited in this respect.

The processes of the various inventive embodiments are intended to divide bandwidth granted to a particular subscriber station among all connections active in the station efficiently and in a fair manner, taking into account the service class and QoS requirements of each connection.

Depending on QoS requirements of connections active in subscriber station, data portions may be identified 410 sent are stored 420, 425 in two or more types of queues. In one embodiment, classes of data that does not require pre-grant UL bandwidth, such as data for a UGS connection, may be stored or identified 420 in a first (high priority) type of queue and classes of data which typically require an uplink bandwidth request and grant, such as data for RT, nRT and BE connections, may be stored or identified 425 in a second (lower priority) type of queue.

The subscriber station MAC scheduling process may then fill 430, 435 available UL bursts by polling these queues in a predetermined manner. For example, UGS connection queues may be polled in round robin (RR) fashion, while the type of queue set(s) are polled in weighted round robin fashion (WRR).

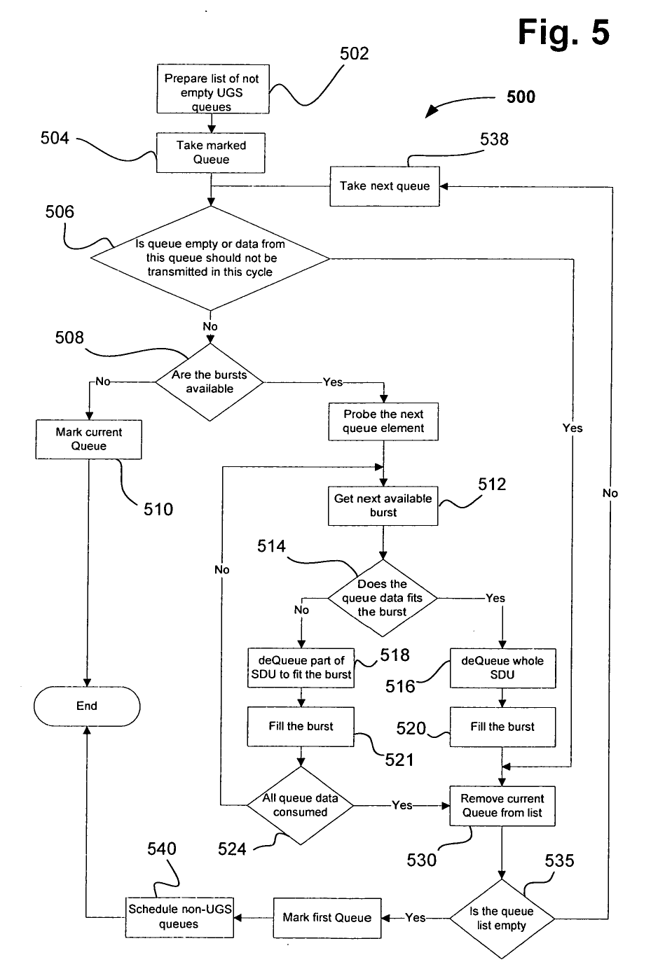

Filling available bursts according to the MAC subscriber station scheduling procedure 400 may be executed upon reception a bandwidth grant (defined as a number of UL bursts of variable length that the subscriber station can use to send its data) from the base station. Burst space may generally used to serve UGS queues first, for example on a round robin basis as described hereafter in reference to FIG. 5. Subsequently, RT, nRT and BE queues may be emptied according to a weighted round robin fashion, an embodiment of which is discussed below.

In one non-limiting embodiment, referring to FIG. 5, a process 500 for a subscriber station to schedule data for uplink communication to a base station for connections not requiring pre-requested bandwidth may begin at box 502 where a list is made or retrieved of all UGS connection queues which have data to be sent. The first queue marked 504 for round robin filling of bursts is checked 506 to see whether the queue does in fact have data waiting to be sent and if so, optionally, whether the data is supposed to be sent in the current serving cycle. If no bursts are available in the current UL bandwidth grant 508, the current queue is marked 510 for sending in the next UL bandwidth grant. However, if bursts are available 508, the bursts may be filled 520, 521 by a process which may include determining 514 if the queued data will fit in the next available burst 512. In certain embodiments, if 514 a data segment (e.g., a SDU) in the current queue will fit entirely within a burst, the whole SDU is de-queued, used to fill 520 the burst. If 514 the SDU cannot fit in the available burst, if possible, the SDU may be de-queued and fragmented 518 to fill the burst 521 and the remaining fragment(s) of the SDU put into the next available bursts 512-521.

When the queue is emptied 516, 524 the queue may be removed 530 from the list and the process is repeated for the next queue 538 on the list until all UGS connection queues are emptied 535. When all UGS queues are empty, process 500 may schedule 540 data in non-UGS type queues for uplink transmission.

Scheduling uplink data for non-UGS connections may include scheduling data in a weighted round robin fashion as mentioned previously in reference to FIG. 4, although the inventive embodiments are not limited in this respect.

In one embodiment each queue for the queue set for these types of connections may be assigned a weight, which for example, may denote the largest portion of data that may be consumed in a single serving cycle (SC). The more demanding the QoS requirement for a connection, a correspondingly higher weight may be assigned for the respective queue. Accordingly, taking into account the weight of each queue, a serving cycle may be constructed. For example, SC={a,a,a,b,b,c} may mean that queue “a” has the highest priority (or weight) and will be served three consecutive times (e.g., three portions of data can be consumed). Subsequently, queue “b” would be served twice, and queue “c” (with the lower priority data) would be served once in the service cycle.

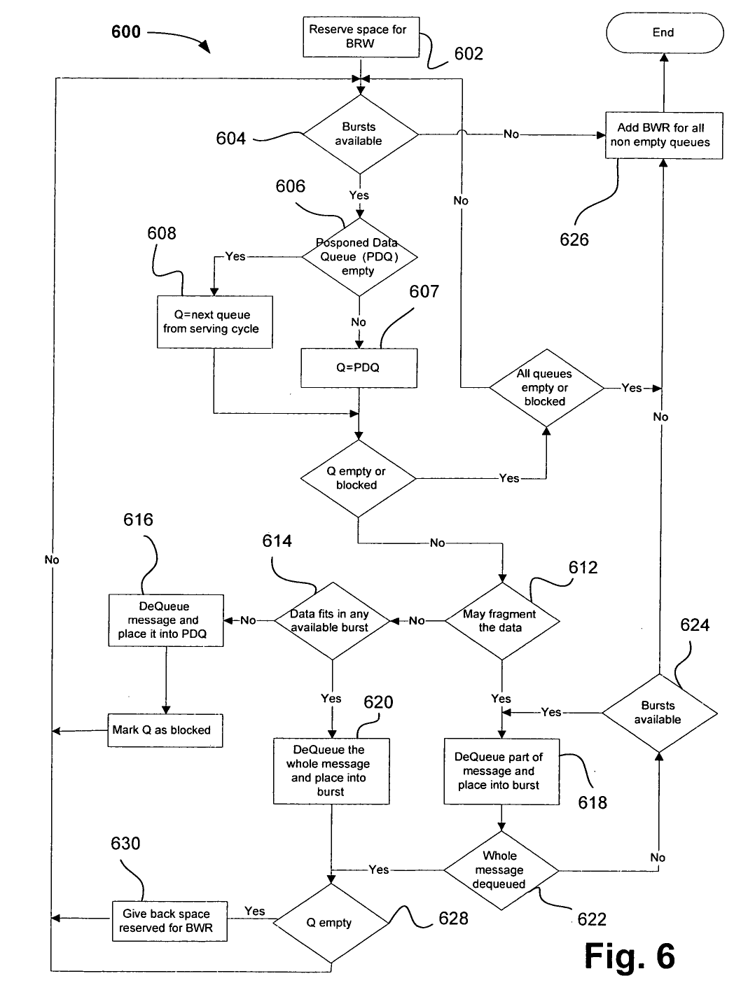

Turning to FIG. 6, a scheduling process 600 may begin, if desired, by reserving 602 space in the available uplink grant for bandwidth requests (BWRs) of data in the queues to be served. In one embodiment, a bandwidth request is attached to the data from each non-UGS queue (UGS connections have bandwidth automatically allocated by a base station). The BWR value may be calculated based on queue occupancy. Initially, each queue may reserve 602 some space in the available UL grant to place at least its BWR. If, after being served, the queue becomes empty, the reserved space may be freed and, for example, used by other queues. Initial allocation of bandwidth request space may increase robustness and effectiveness of uplink scheduling by allowing each queue to request bandwidth. This allows lower priority queues (e.g., for best effort connections) to avoid suffering from bandwidth starvation as a result of their bandwidth being “stolen” by higher priority queues.

If 604, after reserving 602 space for bandwidth requests, there are bursts available in the uplink grant, the next non-UGS queue in the serving cycle may be served 608. In one embodiment, a postponed data queue (PDQ) may be used to house data that was part of a previous service cycle but, for some reason was unable to be sent in the previous UL grant. For example, if a message that cannot be fragmented 612 and does not fit 614 in any of the remaining UL bursts, it may be placed 616 in the postponed data queue (PDQ). During the next execution of the scheduling process 600, messages from PDQ may be processed 606, 607 in the first order.

The queue being served, and that includes data which may be made to fit in available UL bursts, e.g., fragmented 612 or whole 614, is de-queued 618, 620 into the burst(s). If 622 data remains in any queues and there are no more available bursts 604, 624, a bandwidth request for all non-empty queues may be placed 626 in the reserved space 602. If 628, on the other hand, all queues are empty, the space reserved 602 for the bandwidth request may be released 630.

It should be recognized that the detailed processes 500, 600 for scheduling UL data are only examples of possible implementation of the inventive embodiments and that many variations are possible. For example, a serving cycle can be implemented as lists of queues to serve or the postponed data queue can be implemented as a set of markers specifying which queues should be temporarily handled with highest priority, etc. Thus generally speaking, any subscriber station uplink scheduling process which: (i) serves UGS connections before other connections; (ii) serves non-UGS connections in a weighted round robin fashion; (iii) provides initial burst allocation for bandwidth requests; or (iv) postpones data from some queues, may be considered within the scope of the inventive embodiments.

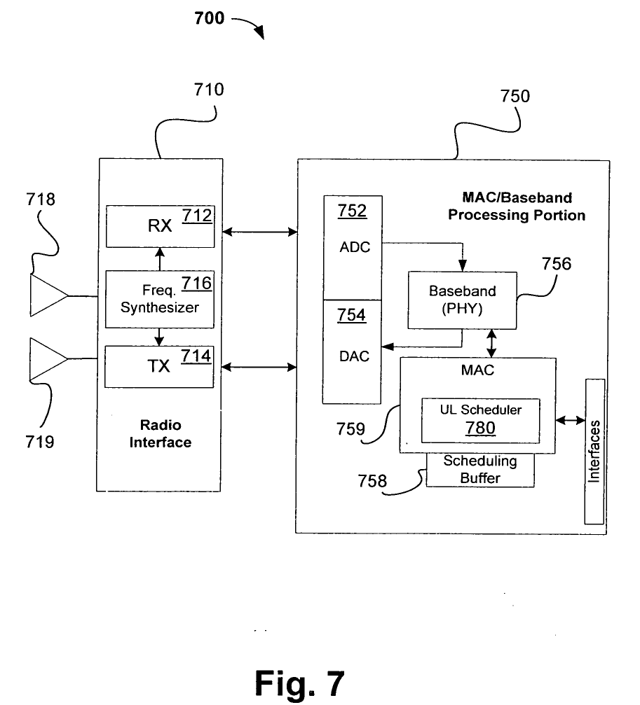

Referring to FIG. 7, a mobile station or subscriber station 700 for use in a wireless network may include a processing circuit 750 including logic (e.g., circuitry, processor and software, or combination thereof) to schedule uplink traffic for more than one active connection as described in one or more of the processes above. In certain embodiments, station 700 may generally include a radio frequency (RF) interface 710 and a medium access controller (MAC) processor portion 750.

In one example embodiment, RF interface 710 may be any component or combination of components adapted to send and receive multi-carrier modulated signals (e.g., OFDM) although the inventive embodiments are not limited to any specific over-the-air interface or modulation scheme. RF interface 710 may include, for example, a receiver 712, a transmitter 714 and a frequency synthesizer 716. Interface 710 may also include bias controls, a crystal oscillator and/or one or more antennas 718, 719 if desired. Furthermore, RF interface 710 may alternatively or additionally use external voltage-controlled oscillators (VCOs), surface acoustic wave filters, intermediate frequency (IF) filters and/or radio frequency (RF) filters as desired. Various RF interface designs and their operation are known in the art and the description thereof is therefore omitted.

In some embodiments interface 710 may be configured to be compatible with one or more of the IEEE 802.16 standards contemplated for broadband wireless networks, although the embodiments are not limited in this respect.

Processing portion 750 may communicate with RF interface 710 to process receive/transmit signals and may include, by way of example only, an analog-to-digital converter 752 for down converting received signals, a digital-to-analog converter 754 for up converting signals for transmission, and if desired, a baseband processor 756 for physical (PHY) link layer processing of respective receive/transmit signals. Processing portion 750 may also include or be comprised of a processing circuit 759 for medium access control (MAC)/data link layer processing.

In certain embodiments of the present invention, MAC processing circuit 759 may include an uplink scheduler 780, in combination with additional circuitry such as buffer memory 758, may function to queue, de-queue or otherwise schedule MAC SDUs for uplink transmission to a base station. Alternatively or in addition, baseband processing circuit 756 may share processing for certain of these functions or perform these processes independent of MAC processing circuit 759. MAC and PHY processing may also be integrated into a single circuit if desired.

Apparatus 700 may be, for example, a wireless mobile station, wireless router or NIC and/or network adaptor for computing devices. Accordingly, the previously described functions and/or specific configurations of apparatus 700 could be included or omitted as suitably desired.

Embodiments of apparatus 700 may be implemented using single input single output (SISO) architectures. However, as shown in FIG. 7, certain preferred implementations may use multiple input multiple output (MIMO) architectures having multiple antennas (e.g., 718, 719) for transmission and/or reception. Further, embodiments of the invention may utilize multi-carrier code division multiplexing (MC-CDMA) multi-carrier direct sequence code division multiplexing (MC-DS-CDMA) for OTA link access or any other existing or future arising modulation or multiplexing scheme compatible with the features of the inventive embodiments.

The components and features of station 700 may be implemented using any combination of discrete circuitry, application specific integrated circuits (ASICs), logic gates and/or single chip architectures. Further, the features of apparatus 700 may be implemented using microcontrollers, programmable logic arrays and/or microprocessors or any combination of the foregoing where suitably appropriate (collectively or individually referred to as “logic” or “circuit”).

It should be appreciated that the example station 700 shown in the block diagram of FIG. 7 represents only one functionally descriptive example of many potential implementations. Accordingly, division, omission or inclusion of block functions depicted in the accompanying figures does not infer that the hardware components, circuits, software and/or elements for implementing these functions would be necessarily be divided, omitted, or included in embodiments of the present invention.

Unless contrary to physical possibility, the inventors envision the methods described herein: (i) may be performed in any sequence and/or in any combination; and (ii) the components of respective embodiments may be combined in any manner.

Although there have been described example embodiments of this novel invention, many variations and modifications are possible without departing from the scope of the invention. Accordingly the inventive embodiments are not limited by the specific disclosure above, but rather should be limited only by the scope of the appended claims and their legal equivalents.

The invention claimed is:

1. A method for communicating in a wireless network comprising:
scheduling data to be transmitted to a base station by a subscriber station having at least two or more active service connections wherein priority is given to data for unsolicited grant service (UGS) connections before non-UGS connections.

2. The method of claim 1 wherein scheduling data to be transmitted for multiple UGS connections is performed on a round robin basis.

3. The method of claim 1 wherein subsequent priority is given to data for non-UGS connections on a weighted round robin basis.

4. The method of claim 1 wherein scheduling comprises dividing the data to be transmitted into two sets of queues including one or more UGS connection queues and one or more non-UGS connection queues.

5. The method of claim 4 wherein the non-UGS connection queues may include data for at least one of real time (RT), non-real-time (nRT), or best effort (BE) traffic classes.

6. The method of claim 5 wherein the non-UGS connection queues may further include data postponed from transmission in a previous service cycle.

7. The method of claim 1 wherein scheduling for non-UGS connections includes reserving at least part of an initial burst of a bandwidth grant from the base station for a bandwidth request.

8. The method of claim 1 further comprising transmitting the scheduled data as one or more bursts of uplink radio frame.

9. A mobile station for use in a wireless network, the station comprising:
a scheduler to independently schedule uplink transmission of data for two or more active service connections, wherein the scheduler reserves initial burst space for bandwidth requests which may be associated with queued data.

10. The apparatus of claim 9 wherein the data for the two or more active service connections are stored in at least one of two types of service connection queues including a first queue set for connections which do not require the bandwidth requests and a second queue set for connections which do require the bandwidth requests.

11. The apparatus of claim 10 wherein the scheduler schedules data to be transmitted from the first queue set before the second queue set.

12. The apparatus of claim 11 wherein data from the first queue set is served on a round robin basis and wherein data from the second queue set is served on a weighted round robin basis.

13. The apparatus of claim 10 wherein the first queue set is reserved data for unsolicited grant service (UGS) connections and wherein the second queue set is reserved for data for non-UGS connections including at least one of real time, non-real time and best effort connections.

14. The apparatus of claim 10 wherein the second queue set includes at least one queue for storing data postponed from being sent in a previous service cycle.

15. The apparatus of claim 9 further comprising a transmission circuit to transmit the data as scheduled by the scheduler in granted bursts of an uplink radio frame.

16. The apparatus of claim 15 wherein the transmission circuit is adapted to transmit the data using multi-carrier modulated radio signals.

17. A system for wireless communications, the system comprising:
a processing circuit to schedule data of at least two active connections for uplink transmission to a base station; and
a radio interface circuit coupled to the processing circuit the radio interface including at least two antennas to transmit the data in the form of radio signals;
wherein the data is scheduled for uplink transmission for any unsolicited grant service (UGS) connections before uplink data for any non-UGS connections.

18. The system of claim 17 wherein the processing circuit includes at least two sets of queues, a first queue set to store data for UGS connections and a second queue set to store data for non-UGS connections, and wherein the first queue set is scheduled in a round robin fashion and the second queue set is scheduled in a weighted round robin fashion.

19. The system of claim 18 wherein scheduling data in the second queue set includes reserving initial burst allocation of a remaining uplink grant for bandwidth requests.

20. They system of claim 18 wherein the second queue set includes at least one postponed data queue to store data from the second queue set which could not be sent in a previous uplink transmission.

21. An article of manufacture comprising a tangible medium having machine readable instructions stored thereon, the machine readable instructions when executed by a processing platform results in:
scheduling data to be transmitted to a base station by a subscriber station having at least two or more active service connections, the scheduling giving priority to data for the subscriber station's unsolicited grant service (UGS) connections before non-UGS connections.

22. The article of claim 21 wherein the machine readable instructions further cause the processing platform to divide the data to be transmitted into two sets of queues including one or more UGS connection queues and one or more non-UGS connection queues.

23. The article of claim 22 wherein the machine readable instructions further cause the processing platform to reserve at least part of an initial burst of an available bandwidth grant for a bandwidth request, when scheduling uplink transmission from the non-UGS connection queues.

24. The article of claim 22 wherein the non-UGS connection queues include a postponed data queue.

25. The article of claim 22 wherein there are two or more non-UGS connection queues are wherein the machine readable instructions further cause the processing platform to schedule uplink transmission from the two or more non-UGS connection queues on a weighted round robin basis.

26. The article of claim 25 wherein weights for the two or more non-UGS connection queues are assigned based on a quality of service (QoS) classification of a service connection associated with each non-UGS connection queue.
